(19) United States
(12) Patent Application Publication
(10) Pub. No.: US 2014/0064038 A1
(43) Pub. Date: Mar. 6, 2014

(54) PILLBOX AND ALARM CLOCK

(71) Applicant: William Wesley Duer, JR., Elmira, OR (US)

(72) Inventor: William Wesley Duer, JR., Elmira, OR (US)

(21) Appl. No.: 13/605,526

(22) Filed: Sep. 6, 2012

(51) Int. Cl. G04B 47/00

(52) U.S. Cl. 368/10

(57) ABSTRACT

The present invention is a pillbox and alarm clock that includes a base pillbox, a removable clock outlet to receive a removable clock, a plurality of compartments that form the base pillbox, the removable clock outlet extends from one of the compartments to receive the removable clock and a plurality of trays that are stacked in each of the compartments. The pillbox and alarm clock additionally includes a pill cutter contained in one of the trays of the base pillbox and is utilized to cut one or more pills if desired, a safety lock placed on one of the compartments utilized for a specific day, a removable clock inlet that extends from the removable clock and a battery that provides electrical power to the removable clock.

### TECHNICAL FIELD & BACKGROUND

Occasionally, a doctor may prescribe a patient with one or more medications that are required to be taken daily at one or more specific times. If the patient neglects to take a medication on schedule, it can lead to complications.

The present invention generally relates to a pillbox. More specifically, the invention is a pillbox and alarm clock.

It is an object of the invention to provide a pillbox and alarm clock that provides a safety lock on each of a plurality of compartments.

It is an object of the invention to provide a pillbox and alarm clock that provides a removable alarm and clock to indicate when to take one or more particular medications.

It is an object of the invention to provide a pillbox and alarm clock that utilizes a plurality of blinking lights and a vibrating device to indicate to a user to take one or more medications.

What is really needed is a pillbox and alarm clock that provides a safety lock on each of a plurality of compartments that provides a removable alarm and clock to indicate when to take one or more particular medications that utilizes a plurality of blinking lights and a vibrating device to indicate to a user to take one or more medications.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a top view of a pillbox and alarm clock, according to an embodiment of the present invention.

FIG. 1B illustrates a front view of a removable clock of a pillbox and alarm clock, according to an embodiment of the present invention.

FIG. 1C illustrates an electrical block diagram of a removable clock of a pillbox and alarm clock, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

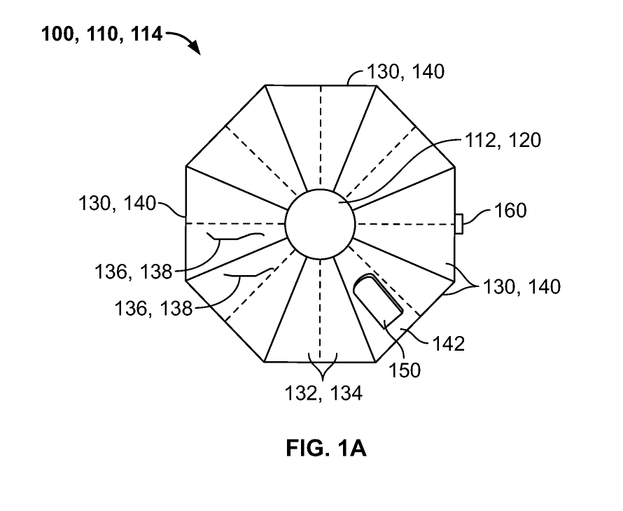

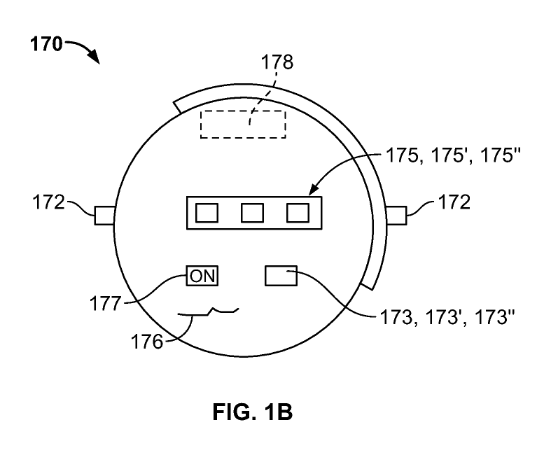

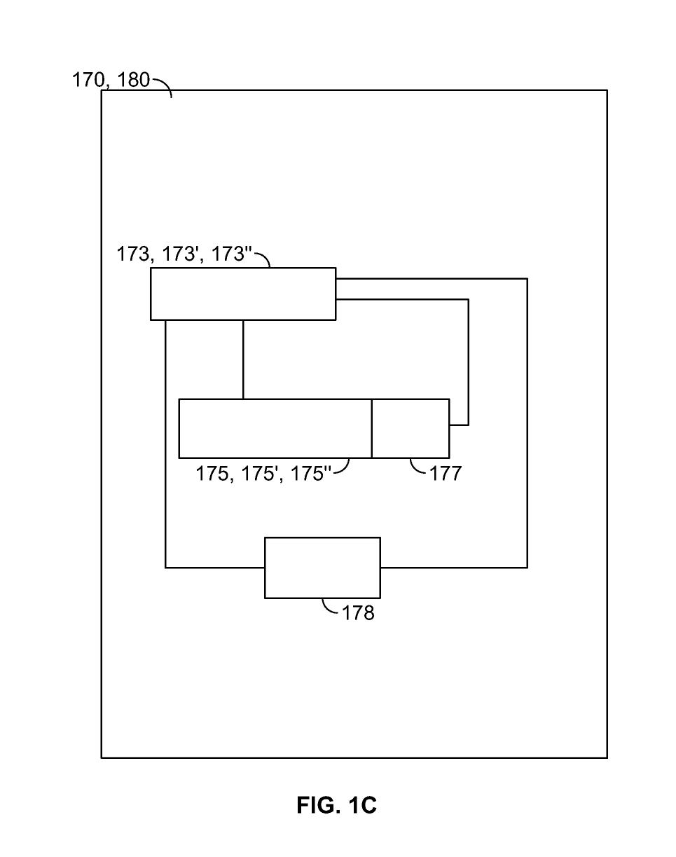

FIG. 1A illustrates a top view of a pillbox and alarm clock 100, according to an embodiment of the present invention.

The pillbox and alarm clock 100 includes a base pillbox 110, a removable clock outlet 120, a plurality of compartments 130, a plurality of trays 140, a pill cutter 150 and a safety lock 160. The base pillbox 110 has a top 112 and has a general octagonal shape 114, although the base pillbox 110 can have any suitable shape such as a circular shape. The base pillbox 110 can be made of plastic, metal or any suitable material. The removable clock outlet 120 receives a removable clock (FIG. 1B, 170). Additional details regarding the removable clock 170 are illustrated and described in FIG. 1B and its description. The compartments 130 include 8 adjacent compartments 130 that form the base pillbox 110, although the base pillbox 110 can be formed from any suitable number of compartments 130 such as 7 compartments, 14 compartments or 28 compartments. The removable clock outlet 120 extends from one of the compartments 130 to receive the removable clock (FIG. 1B, 170). The compartments 130 each have a removable clock outlet 120 to receive a removable clock (FIG. 1B, 170). The compartments 130 each have an AM divider 132 and a PM divider 134 and have a first set of braille 136 disposed on each compartment 130 with suitable information that indicates a name of a day of a week 138 (i.e., Tuesday). The trays 140 are stacked in each compartment 130. There are 4 trays 140 vertically stacked in each compartment 130 to accommodate a daily dosage of one or more pills, capsules or tablets (not shown) contained in each tray 140. The 4 vertically stacked trays 140 in each of the 8 compartments 130 form 32 trays 140 to accommodate up to a 31 day dosage of one or more pills, capsules or tablets (not shown) contained in each tray 140, although any suitable number of trays 140 and compartments 130 can form the base pillbox 110. The pillbox and alarm clock 100 and trays 140 can accommodate a daily, a weekly and a bi-weekly dosage of one or more pills, capsules or tablets. The one or more pills, capsules or tablets can be any suitable pills, capsules or tablets that can fit in each tray 140. The pill cutter 150 is contained in the 32rd tray 142 of the base pillbox 110 and can be utilized to cut a pill if desired. The safety lock 160 is placed on a compartment 130 that is utilized for a specific day, which is typically the day that a user takes the one or more pills, capsules or tablets contained in the compartment 130 locked by the safety lock 160.

FIG. 1B illustrates a front view of a removable clock 170 of a pillbox and alarm clock 100, according to an embodiment of the present invention.

The pillbox and alarm clock 100 illustrated and described in FIG. 1A are similar to the pillbox and alarm clock 100 illustrated and described in FIG. 1B. The pillbox and alarm clock 100 includes a removable clock 170 with a removable clock inlet 172 and a battery 173. The removable clock inlet 172 can be removably inserted into any removable clock outlet 120 disposed on any of the 8 adjacent compartments 130. The removable clock 170 can be transferred from one removable clock outlet 120 of a compartment 130 to another removable clock outlet 120 of another compartment 130. The removable clock 170 has a plurality of blinking indicator lights 175 and a second set of braille 176 disposed on the removable clock 170 that can indicate suitable removable clock related information. The blinking indicator lights 175 include an on indicator light 177 that can blink to indicate to a deaf person that the removable clock 170 is activated. The blinking indicator lights 175 can be light emitting diode or LED lights 175′, liquid crystal diode or LCD lights 175″ or other suitable type of lights. The removable clock 170 also includes a vibrator device 178 that vibrates the removable clock 170 so a visually impaired person can recognize when the removable clock 170 is activated. The battery 173 provides electrical power to the removable clock 170 and can be an alkaline battery 173′, a lithium battery 173″ or other suitable type and size of battery. Additional details regarding the battery 173 and related electrical components of the removable clock 170 are illustrated and described in FIG. 1C and its description.

FIG. 1C illustrates an electrical block diagram 180 of a removable clock 170 of a pillbox and alarm clock 100, according to an embodiment of the present invention.

The electrical drawing 180 includes similar components of the removable clock 170 that include a similar battery 173 such as an alkaline battery 173′ or a lithium battery 173″, blinking indicator lights 175, an on indicator light 177, light emitting diode or LED lights 175′ or liquid crystal diode or LCD lights 175″ and a vibrator device 178. The battery 173 such as an alkaline battery 173′ or a lithium battery 173″, provides electrical power to the blinking indicator lights 175 such as light emitting diode or LED lights 175′ or liquid crystal diode or LCD lights 175″, the on indicator light 177 and the vibrator device 178.

The pillbox and alarm clock is an organizer for one or more tablets, capsules or pill medications. The pillbox and alarm clock has a general octagon shape and four trays, each of which has eight slots for the one or more tablets, capsules or pill medications. A child-proof lock prevents tampering while an alarm may vibrate or light-up as a reminder for a user. Pharmacists are among the many people who may find the pillbox and alarm clock relatively convenient and easy to use. The pillbox and alarm clock features a multiple use container for one or more tablets, capsules or pill medications. The pillbox and alarm clock is designed to be available in a variety of styles and colors.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pillbox and alarm clock, comprising:
a base pillbox with a top;
a removable clock outlet to receive a removable clock;
a plurality of compartments that form the base pillbox, the removable clock outlet extends from one of the compartments to receive the removable clock;
a plurality of trays that is stacked in each of the compartments;
a pill cutter contained in one of the trays of the base pillbox, the pill cutter is utilized to cut one or more pills if desired;
a safety lock placed on one of the compartments utilized for a specific day, which is the specific day that a user takes a selected one of the one or more pills, one or more capsules and one or more tablets contained in the compartment locked by the safety lock;
a removable clock inlet that extends from the removable clock, the removable clock inlet is inserted into the removable clock outlet, the removable clock outlet is disposed on one of the compartments; and
a battery that provides electrical power to the removable clock.

2. The pillbox and alarm clock according to claim 1, wherein the base pillbox has a general octagonal shape.

3. The pillbox and alarm clock according to claim 1, wherein the pillbox is made of a selected one of metal and plastic.

4. The pillbox and alarm clock according to claim 1, wherein the compartments include 8 compartments.

5. The pillbox and alarm clock according to claim 1, wherein the compartments have a first set of braille disposed on each of the compartments, the first set of braille indicates a name of a day of a week.

6. The pillbox and alarm clock according to claim 1, wherein the trays include 4 trays vertically stacked in each of the compartments.

7. The pillbox and alarm clock according to claim 1, wherein the trays each accommodate a daily dosage of the selected one of the one or more pills, one or more capsules and one or more tablets.

8. The pillbox and alarm clock according to claim 1, wherein the trays accommodate up to a 31 day dosage of the selected one of the one or more pills, one or more capsules and one or more tablets.

9. The pillbox and alarm clock according to claim 1, wherein the pillbox and alarm clock and the trays accommodate a daily, a weekly and a bi-weekly dosage of the selected one of the one or more pills, one or more capsules and one or more tablets.

10. The pillbox and alarm clock according to claim 1, wherein the removable clock has a plurality of blinking indicator lights and a second set of braille disposed on the removable clock, the second set of braille indicates removable clock related information.

11. The pillbox and alarm clock according to claim 10, wherein the blinking indicator lights include an on indicator light that blinks to indicate to a deaf person that the removable clock is activated.

12. The pillbox and alarm clock according to claim 1, wherein the removable clock includes a vibrator device, the vibrator device vibrates the removable clock so a visually impaired person recognizes when the removable clock is activated.

13. The pillbox and alarm clock according to claim 1, wherein the battery is a selected one of an alkaline battery and a lithium battery.

14. A pillbox and alarm clock, comprising:
a general octagonal shape base pillbox with a top;
a removable clock outlet to receive a removable clock, the removable clock includes a vibrator device, the vibrator device vibrates the removable clock so a visually impaired person recognizes when the removable clock is activated;
8 compartments that form the base pillbox, the removable clock outlet extends from one of the compartments to receive the removable clock, the compartments each have an AM divider and a PM divider, the compartments have a first set of braille disposed on each of the compartments, the first set of braille indicates a name of a day of a week;
4 trays vertically stacked in each of the compartments, the trays each accommodate a daily dosage of a selected one of one or more pills, one or more capsules and one or more tablets, the pillbox and alarm clock and the trays accommodate a daily, a weekly and a bi-weekly dosage of the selected one of the one or more pills, one or more capsules and one or more tablets;
a pill cutter contained in one of the trays of the base pillbox, the pill cutter is utilized to cut the one or more pills if desired;
a safety lock placed on one of the compartments utilized for a specific day, which is the specific day that a user takes the selected one of the one or more pills, one or more capsules and one or more tablets contained in the compartment locked by the safety lock;
a removable clock inlet that extends from the removable clock, the removable clock inlet is inserted into the removable clock outlet, the removable clock outlet is disposed on one of the compartments, the removable clock has a plurality of blinking indicator lights and a second set of braille disposed on the removable clock, the second set of braille indicates removable clock related information, the blinking indicator lights include an on indicator light that flashes to indicate to a deaf person that the removable clock is activated; and
a battery that provides electrical power to the removable clock.

15. The pillbox and alarm clock according to claim 14, wherein the pillbox is made of metal.

16. The pillbox and alarm clock according to claim 14, wherein the pillbox is made of plastic.

17. The pillbox and alarm clock according to claim 14, wherein the blinking indicator lights are LED lights.

18. The pillbox and alarm clock according to claim 14, wherein the blinking indicator lights are LCD lights.

19. The pillbox and alarm clock according to claim 14, wherein the battery is an alkaline battery.

20. The pillbox and alarm clock according to claim 14, wherein the battery is a lithium battery.
